(19) United States
(12) Patent Application Publication
(10) Pub. No.: US 2025/0298257 A1
(43) Pub. Date: Sep. 25, 2025

(54) INTELLIGENT GLASSES, AND INTELLIGENT DEVICE

(71) Applicants: Asphetek Solution (Chengdu) Ltd., Chengdu (CN); ADVANCED OPTOELECTRONIC TECHNOLOGY, INC., Hsinchu County (TW); Asphetek Solutions Inc., Hsinchu (TW)

(72) Inventors: YUAN-TING LIANG, Hsinchu (TW); Ying-Hung Tsai, Hsinchu (TW)

(21) Appl. No.: 18/928,424

(22) Filed: Oct. 28, 2024

(30) Foreign Application Priority Data
Mar. 19, 2024 (CN) 202420535055.1

(51) Int. Cl. G02B 27/01; G02C 5/14; G02C 11/00

(52) U.S. Cl. CPC G02B 27/0179; G02B 27/0172; G02B 27/0176; G02C 5/146; G02C 11/10; G02B 2027/0154; G02B 2027/0178; G02B 2027/0185

(57) ABSTRACT

This application provides intelligent glasses and intelligent device. The intelligent glasses include a glasses frame, a distance measuring element, one or more electronically controlled zoom lenses, optical machines and waveguide plates. The distance measuring element is provided on an outer side of the glasses frame. The electronically controlled zoom lenses are provided in the glasses frame, one of the electronically controlled zoom lenses is provided with a control circuit, the distance measuring element is in signal connection with the control circuit. The optical machines are provided in the glasses frame, and are corresponding to the electronically controlled zoom lenses, and are electrically connected with the control circuit. The waveguide plates are provided on a side of the electrically controlled zoom lenses away from the optical machines, lights emitted by the optical machines are projected to the corresponding waveguide plates by the corresponding electrically controlled zoom lenses.

### FIELD

The present disclosure relates to field of intelligent image equipment technology, and in particular to intelligent glasses, and intelligent device.

### BACKGROUND

In some existing technologies of augmented reality/mixed reality glasses, a focal length of an image projected by glasses is generally fixed. However, focal lengths of different objects in a real environment are different because of distances of the different objects, so there are different focal lengths between a virtual image and the real environment. This makes user's eye focus need to change frequently when moving between the virtual image and the real environment, which is easy to cause the user to feel dizzy.

Thus, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 shows a structure view of intelligent glasses of a present application in an embodiment.

FIG. 2 shows a partial structure view of electronically controlled zoom lens, optical machine and waveguide plate of the intelligent glasses shown in FIG. 1.

FIG. 3 shows a structure view of intelligent glasses of a present application in an embodiment.

FIG. 4 shows a structure view of intelligent glasses of a present application in an embodiment.

FIG. 5 shows a structure view of an intelligent device of a present application in an embodiment.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it in one embodiment indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein includes any and all combinations of one or more of associated listed items.

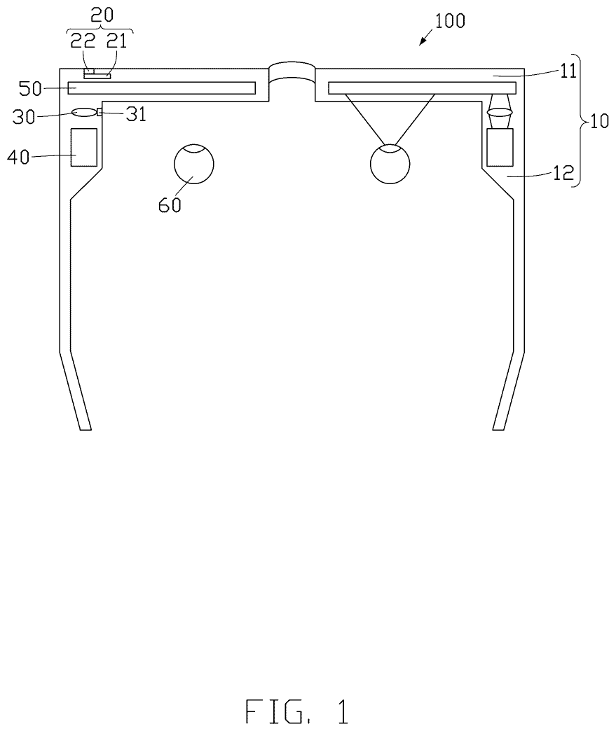

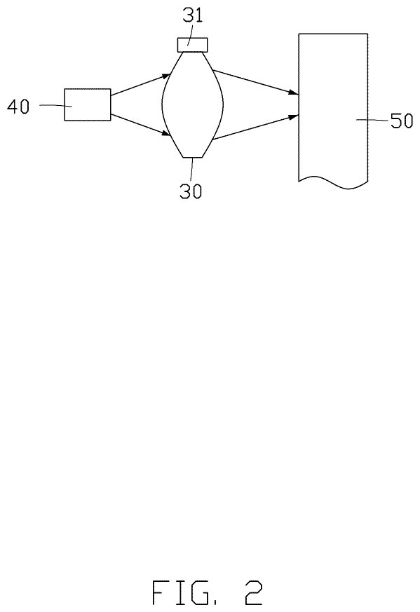

Referring to FIG. 1 to FIG. 2, in one embodiment, the intelligent glasses 100 includes a glasses frame 10, a distance measuring element 20, one or more electronically controlled zoom lenses 30, one or more optical machines 40, and one or more waveguide plates 50. The distance measuring element 20 is arranged on an outer side of the glasses frame 10. The distance measuring element 20 is partially exposed to an outer surface of the glasses frame 10 and is configured to detect distances between surrounding environmental goods and one user using the intelligent glasses 100. The electronically controlled zoom lenses 30 are arranged in the glasses frame 10, one of the electronically controlled zoom lenses 30 is provided with a control circuit 31, the distance measuring element 20 is in signal connection with the control circuit 31. The control circuit 31 is configured to adjust output signals of the electronically controlled zoom lenses 30 according to detection signals of the distance measuring element 20, and then adjust focal lengths of the electronically controlled zoom lenses 30. The optical machines 40 are arranged in the glasses frame 10, the optical machines 40 are corresponding to the electronically controlled zoom lenses 30, the optical machines 40 are electrically connected with the control circuit 31. The waveguide plates 50 are located on a side of the electrically controlled zoom lenses 30 away from the optical machines 40, lights emitted by the optical machines 40 are projected to the corresponding waveguide plates 50 by the corresponding electrically controlled zoom lenses 30. The distance measuring element 20 detects distances between the surrounding environmental goods and the user in real time, each one of the electronically controlled zoom lenses 30 adjusts a focal length according to the distance, so that the lights emitted by the optical machines 40 can change projection focal lengths by the electronically controlled zoom lenses 30 and the waveguide plates 50. Thus, a virtual image matching the focal length of a surrounding real environment can be presented in the user's sight line to reduce the user's sense of dizziness.

In one embodiment, the glasses frame 10 includes a frame body 11 and two glasses legs 12, the two glasses legs 12 are connected to both sides of the frame body 11 and are configured to support the frame body 11. The waveguide plates 50 are arranged in the frame body 11, and the waveguide plates 50 are fitted to the corresponding lenses in the frame body 11 for transmitting the image lights generated by the optical machines 40 to the user's eyeballs 60, and the waveguide plates 50 covers the corresponding sight lines of the user's eyeballs 60. A type of each one of the waveguide plates 50 can be reflected, diffraction, holographic, etc. A material of each one of the waveguide plates 50 can be PC, PMMA, PI, glass, sapphire, etc. A thickness of each one of the waveguide plates 50 is 0.1 mm˜2 mm.

The distance measuring element 20 and the electronically controlled zoom lenses 30 are located on opposite sides of the waveguide plates 50 respectively. The distance measuring element 20 is located on one side of the frame body 11 away from the user's eyeballs 60. Each one of the electronically controlled zoom lenses 30 is set coaxially with corresponding optical machine 40. The electronically controlled zoom lenses 30 are provided with two, and the optical machines 40 are provided with two. One of the two electronically controlled zoom lenses 30 and one of the two optical machines 40 are arranged at one end of one of the two glasses legs 12 connected to the frame body 11. The other one of the two electronically controlled zoom lenses 30 and the other one of the two optical machines 40 are arranged at one end of the other one of the two glasses legs 12 connected to the frame body 11. The control circuit 31 adjusts current or voltage signal outputs to the electronically controlled zoom lenses 30 according to detection signals of the distance measuring element 20, the electronically controlled zoom lenses 30 adjust positions of the lenses or curvatures of the lenses according to received signals, so as to achieve a purpose of adjusting focal lengths, so that the focal length of the projected virtual image matches the surrounding environment goods.

In one embodiment, one set of one of the two electronically controlled zoom lenses 30 and one of the two optical machines 40 and another set of the other one of the two electronically controlled zoom lenses 30 and the other one of the two optical machines 40 are symmetrically arranged in two glasses legs 12 to match the corresponding waveguide plates 50 respectively. In other embodiments, the electronically controlled zoom lenses 30 and the optical machines 40 can also be arranged at a nose bridge support in the middle of the frame body 11 to meet different installation requirements.

In one embodiment, types of the electronically controlled zoom lenses 30 can be liquid crystal lens, electromechanical plastic liquid lens, electromechanical plastic elastomer lens, hydraulic plastic lens, etc. Materials of the lenses can be liquid crystal, glycerin, silicone oil, PVC, PDMS, etc. A size of an aperture of each one of the electronically controlled zoom lenses 30 is 0.1 mm˜10 mm, an overall thickness of each one of the electronically controlled zoom lenses 30 is 0.1 mm˜5 mm. Types of the optical machines 40 can be micro LED, DLP, LCOS, etc., and a brightness of each one of the optical machines 40 is 100˜10000 nits.

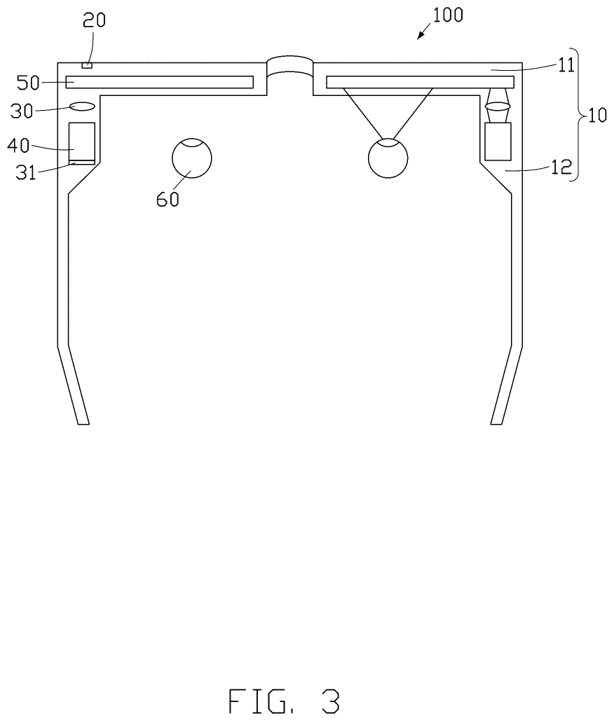

Referring to FIG. 3, in one embodiment, the control circuit 31 is arranged in one of the optical machines 40, the electronically controlled zoom lenses 30 and the other one of the optical machines 40 are electrically connected to the optical machine 40 setting the control circuit 31, so that the optical machines 40 and the electronically controlled zoom lenses 30 share a control circuit 31, thereby improving an overall integration of device. In other embodiments, each one of the electronically controlled zoom lenses 30 can also be arranged in the corresponding optical machine 40. Specifically, each one of the electronically controlled zoom lenses 30 can be assembled at one end of the corresponding optical machine 40, so that the electronically controlled zoom lens 30 and the corresponding optical machine 40 are assembled as a whole, which is convenient for an overall installation and disassembly.

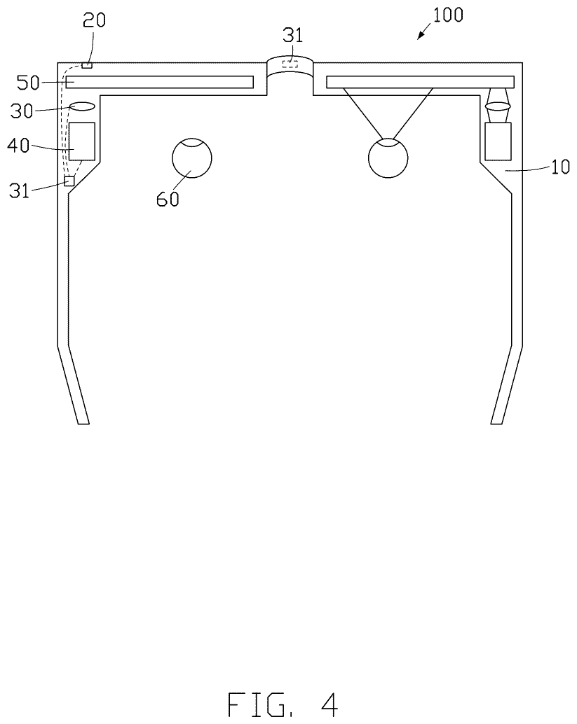

Referring to FIG. 4, in one embodiment, the control circuit 31 can also be arranged in the frame body 11 or one of the glasses legs 12, and the control circuit 31 is electrically connected to the distance measuring element 20, the electronically controlled zoom lenses 30, the optical machines 40 and other components by wires, which is conducive to a reasonable use of an internal space of the glasses frame 10 and a reduction of a size of each component.

Referring to FIG. 4, in one embodiment, the distance measuring element 20 includes one or more light-emitting chips 21 and one or more sensors 22. The one or more light-emitting chips 21 are corresponding to the one or more sensors 22. Each one of the light-emitting chips 21 is electrically connected with the corresponding sensor 22. The light-emitting chips 21 and the sensors 22 face a front of the user, and the light-emitting chips 21 and the sensors 22 are at least partially exposed to an outer surface of the glasses frame 10, thereby improving detection accuracies. In one embodiment, the distance measuring element 20 is arranged on one side of the frame body 11 near the glasses legs 12. In other embodiments, the distance measuring element 20 can also be arranged on a nose bridge frame in the middle of the frame body 11. This application is not limited to a position of the distance measuring element 20, the position of the distance measuring element 20 is capable of meeting design requirements. In some embodiments, the light-emitting chips 21 can be infrared light chips, and the sensors 22 can be single photon avalanche diodes. The sensors 22 emit infrared rays to the surrounding environment, and the light-emitting chips 21 are configured to receive infrared rays reflected by the surrounding environmental goods and judge distances of the surrounding environmental goods with the user. The light-emitting chips 21 are electrically connected to the control circuit 31 to transmit ranging signals to the control circuit 31.

In one embodiment, a power of each one of the light-emitting chips 21 is 10 mW˜500 mW, an operating wavelength of each one of the light-emitting chips 21 is 700 nm˜1400 nm, and an operating frequency of each one of the light-emitting chips 21 is 1 kHz˜1 MHz. An operating wavelength of each one of the sensors 22 is 700 nm˜1400 nm.

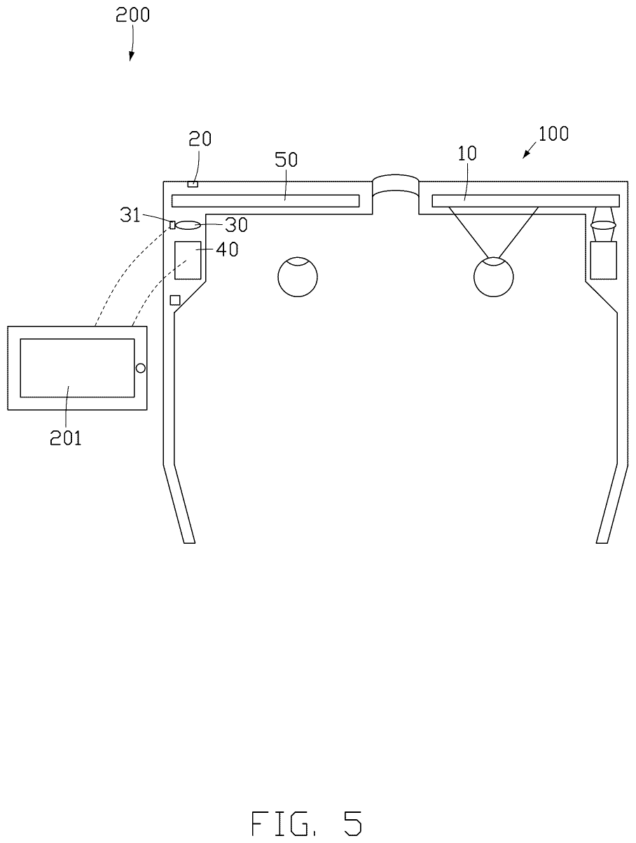

Referring to FIG. 5, in one embodiment, the intelligent device 200 includes a mobile terminal 201 and the intelligent glasses 100 described in the above embodiments. The mobile terminal 201 is in signal connection with the control circuit 31 or the optical machines 40 of the intelligent glasses 100 for transmitting image signals or control instructions to the control circuit 31 or the optical machines 40 to adjust an use state of the intelligent glasses 100 or project an image.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. Intelligent glasses, comprising:
a glasses frame;
a distance measuring element provided on an outer side of the glasses frame;
one or more electronically controlled zoom lenses provided in the glasses frame, one of the electronically controlled zoom lenses being provided with a control circuit, the distance measuring element being in signal connection with the control circuit;
one or more optical machines provided in the glasses frame, the one or more optical machines being corresponding to the one or more electronically controlled zoom lenses respectively, the one or more optical machines being electrically connected with the control circuit;
one or more waveguide plates provided on a side of the electrically controlled zoom lenses away from the optical machines, lights emitted by the optical machines being projected to the corresponding waveguide plates by the corresponding electrically controlled zoom lenses.

2. The intelligent glasses as claimed in claim 1, wherein the glasses frame comprises a frame body and two glasses legs, the two glasses legs are connected to both sides of the frame body, the waveguide plates are arranged in the frame body, and the waveguide plates are configured to transmit lights of optical images generated by the optical machines to user's eyes; the distance measuring element and the electrically controlled zoom lenses are respectively arranged on opposite sides of the waveguide plates, and the distance measuring element is arranged on a side of the frame body away from the user's eyes.

3. The intelligent glasses as claimed in claim 2, wherein the electronically controlled zoom lenses and the optical machines are arranged at an end of the glasses legs connecting the frame body.

4. The intelligent glasses as claimed in claim 1, wherein a size of an aperture of each one of the electronically controlled zoom lenses is 0.1 mm˜10 mm, an overall thickness of each one of the electronically controlled zoom lenses is 0.1 mm˜5 mm.

5. The intelligent glasses as claimed in claim 1, wherein the control circuit is arranged in one of the optical machines, and the electrically controlled zoom lens are electrically connected with the optical machine.

6. The intelligent glasses as claimed in claim 2, wherein the control circuit is arranged in the frame body or one of the two glasses legs, the distance measuring element, the electrically controlled zoom lenses, and the optical machines are electrically connected with the control circuit.

7. The intelligent glasses as claimed in claim 1, wherein the distance measuring element comprises one or more light-emitting chips and one or more sensors, the one or more light-emitting chips are electrically connected with the one or more sensors, the one or more light-emitting chips and the one or more sensors face a front of one user, and the one or more light-emitting chips and the one or more sensors are at least partially exposed to an outer surface of the glasses frame.

8. The intelligent glasses as claimed in claim 7, wherein a power of each one of the light-emitting chips is 10 mW˜500 mW, an operating wavelength of each one of the light-emitting chips is 700 nm˜1400 nm, and an operating frequency of each one of the light-emitting chips is 1 kHz˜1 MHz.

9. The intelligent glasses as claimed in claim 7, wherein an operating wavelength range of each one of the sensors is 700 nm˜1400 nm.

10. An intelligent device, comprising:
a mobile terminal;
intelligent glasses, comprising:
a glasses frame;
a distance measuring element provided on an outer side of the glasses frame;
one or more electronically controlled zoom lenses provided in the glasses frame, one of the electronically controlled zoom lenses being provided with a control circuit, the distance measuring element being in signal connection with the control circuit;
one or more optical machines provided in the glasses frame, the one or more optical machines being corresponding to the one or more electronically controlled zoom lenses respectively, the one or more optical machines being electrically connected with the control circuit;
one or more waveguide plates provided on a side of the electrically controlled zoom lenses away from the optical machines, lights emitted by the optical machines being projected to the corresponding waveguide plates by the corresponding electrically controlled zoom lenses;
wherein the mobile terminal is in signal connection with the control circuit or the optical machines of the intelligent glasses.

11. The intelligent device as claimed in claim 10, wherein the glasses frame comprises a frame body and two glasses legs, the two glasses legs are connected to both sides of the frame body, the waveguide plates are arranged in the frame body, and the waveguide plates are configured to transmit lights of optical images generated by the optical machines to user's eyes; the distance measuring element and the electrically controlled zoom lenses are respectively arranged on opposite sides of the waveguide plates, and the distance measuring element is arranged on a side of the frame body away from the user's eyes.

12. The intelligent device as claimed in claim 11, wherein the electronically controlled zoom lenses and the optical machines are arranged at an end of the glasses legs connecting the frame body.

13. The intelligent device as claimed in claim 10, wherein a size of an aperture of each one of the electronically controlled zoom lenses is 0.1 mm˜10 mm, an overall thickness of each one of the electronically controlled zoom lenses is 0.1 mm˜5 mm.

14. The intelligent device as claimed in claim 10, wherein the control circuit is arranged in one of the optical machines, and the electrically controlled zoom lens are electrically connected with the optical machine.

15. The intelligent device as claimed in claim 11, wherein the control circuit is arranged in the frame body or one of the two glasses legs, the distance measuring element, the electrically controlled zoom lenses, and the optical machines are electrically connected with the control circuit.

16. The intelligent device as claimed in claim 10, wherein the distance measuring element comprises one or more light-emitting chips and one or more sensors, the one or more light-emitting chips are electrically connected with the one or more sensors, the one or more light-emitting chips and the one or more sensors face a front of one user, and the one or more light-emitting chips and the one or more sensors are at least partially exposed to an outer surface of the glasses frame.

17. The intelligent device as claimed in claim 16, wherein a power of each one of the light-emitting chips is 10 mW˜500 mW, an operating wavelength of each one of the light-emitting chips is 700 nm˜1400 nm, and an operating frequency of each one of the light-emitting chips is 1 kHz˜1 MHz.

18. The intelligent device as claimed in claim 16, wherein an operating wavelength range of each one of the sensors is 700 nm˜1400 nm.
